(19) United States
(12) Patent Application Publication
(10) Pub. No.: US 2021/0125156 A1
(43) Pub. Date: Apr. 29, 2021

(54) REAL-TIME DIGITAL RESOURCE DISTRIBUTION RESTORER SYSTEM

(71) Applicant: BANK OF AMERICA CORPORATION, Charlotte, NC (US)

(72) Inventors: Lauren Steinkerchner, Charlotte, NC (US); Clement Valentine Chellaraj, Charlotte, NC (US); Charles Christopher Harbinson, Mooresville, NC (US); Clarence Edward Lee, II, Mansfield, TX (US); Brendan Patrick Spencer Murphy, Charlotte, NC (US); Todd Edward Ratts, Lake George, CO (US)

(73) Assignee: BANK OF AMERICA CORPORATION, Charlotte, NC (US)

(21) Appl. No.: 16/662,526

(22) Filed: Oct. 24, 2019

(51) Int. Cl. G06Q 20/04; H04W 12/06; H04W 12/08; G06Q 20/40; G06Q 20/32; G06K 9/00

(52) U.S. Cl. CPC G06Q 20/042; H04W 12/06; H04W 12/08; G06K 2209/01; G06Q 20/3223; G06K 9/00449; G06K 9/00671; G06Q 20/40

(57) ABSTRACT

Embodiments of the invention are directed to systems, methods, and computer program products for mobile device based real-time resource deposition processing. In this way, a hold recommendation screen may be presented on a mobile device display upon identification of a potential hold on one or more physical resource distribution document depositions. The screen may transmit information regarding the hold to the user based on real-time decisioning at the terminal. The user able to reverse the recommendation and cancel a specific resource distribution document deposition within a group of resource distribution documents based on the processing hold indication.

### BACKGROUND

Mobile devices are commonly used by individuals to perform a variety of activities. A needs exists for improved mobile devices with enhanced distribution interaction capabilities.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The invention provides a real-time paper resource distribution recommendation system. The invention provides a hold recommendation screen and process to a user as the user is depositing checks via a user device. The hold recommendation screen is based on real-time decisions that were made on the backend about check approval. Based on the user's actions at the user device, the system provides the ability to reverse the recommendations if the user asks in real-time. The system notifies the user of a hold and allows the user to cancel a specific item or a group of items and have that item/group returned based on information provided on the screen of the user device.

In this way, the invention allows users to cancel, process, or modify a mobile check deposits if the user receives a hold notification. Furthermore, the system allows the user to view a remaining monthly deposit limit.

Embodiments of the invention relate to systems, methods, and computer program products for real-time physical resource distribution document processing and restoring, the invention comprising: integrating within a user device via an application for management and deposition of physical resource documents by a user; authorizing the user access to the application based on authentication requirement satisfaction by the user; allowing imaging of physical resource distribution documents via the user device for user deposition; performing character recognition on the imaged physical resource distribution documents; performing real-time approval decision processing for each of the imaged physical resource distribution documents; identifying one or more imaged resource distribution documents for holding based on the real-time approval decision processing; presenting, via a display on the user device, the identification of one or more imaged resource distribution documents for holding; allowing user cancelation, confirmation, or request for re-processing of held one or more imaged resource distribution documents; and continuing downstream processing of imaged resource distribution documents not held.

In some embodiments, performing real-time approval decision processing further comprises performing an initial approval decision on the imaged physical resource distribution document to determine if a hold on processing the imaged physical resource distribution document downstream will occur, wherein a hold is based on an identification of an exception or misappropriation.

In some embodiments, presenting, via the display on the user device, the identification of one or more resource distribution documents for holding further comprises displaying an image of the one or more resource distribution documents for holding and a rationale for the holding.

In some embodiments, allowing user cancelation, confirmation, or request for re-processing of held one or more imaged resource distribution documents further comprises triggering a display on the user device allowing for user selection. In some embodiments, allowing for cancelation of the held one or more imaged physical resource distribution documents further comprises returning the physical resource distribution document associated with the held one or more imaged physical resource distribution documents to a pre-processed state, wherein allowing the held one or more imaged physical resource distribution documents to be deposited at another location.

In some embodiments, the physical resource distribution document is a check. In some embodiments, the user device is a mobile device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a real-time digital recommendation restorer system environment, in accordance with embodiments of the present invention;

FIG. 2 illustrates a block diagram of the processing system associated with the real-time digital recommendation restorer system environment, in accordance with embodiments of the present invention;

FIG. 3 illustrates a block diagram of the user device, in accordance with embodiments of the present invention;

FIG. 4 illustrates an exemplary image of a resource distribution document, in accordance with one embodiment of the present invention;

FIG. 5 illustrates a process of triggering real-time resource distribution document restoration, in accordance with embodiments of the present invention;

FIG. 6 illustrates a process of restoring a resource distribution document, in accordance with embodiments of the present invention; and

FIG. 7 illustrates a user device interface during the process of restoring a resource distribution document, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “transaction” or “resource distribution” refers to any communication between a user and the financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In some embodiments, an “entity” may be a financial institution or third party merchant. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

As described herein, a “user” is an individual associated with an entity. As such, in some embodiments, the user may be an individual having past relationships, current relationships or potential future relationships with an entity. In some instances, a “user” is an individual who has a relationship with the entity, such as a customer or a prospective customer. In some instances described herein, the user is an individual who seeks to utilize, operate, or perform one or more activities associated with a user device and an application associated with resource reviewing and distribution, such as a financial, budgeting, or banking application, typically based on successful validation of the user's authentication credentials.

The term “computer terminal” or “user activity terminal” as used herein may refer to one or more electronic devices that facilitate one or more user activities or transactions. Typically, a computer terminal is configured to facilitate performance of one or more user activities by establishing an “interactive session” between a user and the computer terminal. As such, the terms “user activity” or “user transaction” or simply “activity” may refer to financial or non-financial activities, tasks, events or actions. In some embodiments a computer terminal refers to one or more devices that facilitate execution of financial transactions or activities. In this regard, the computer terminals may be an ATM, Point of sale (POS) devices, vending machines, checkout registers, ticket vending machines, automated retail transaction devices, banking terminals in a financial institution, a user device, other computing devices that involve financial user activities or transactions in one form or another, or may comprise technology elements and/or functionality of one or more aforementioned devices, or a suitable combination of the aforementioned devices/apparatuses. In embodiments described herein, performing a user activity or transaction may refer to the initiation, stages during the processing, or completion of a transaction using a user device. This transaction may be the depositing of a check or other physical resource distribution document at the user device. The computer terminal of the present invention is interactive and is configured to communicate with a user using visual, audio or other means, either directly (e.g., using display devices of the computer terminal) or via suitable devices (e.g., via a user mobile device).

Currently, a user may be able to deposit one or more physical resource distribution documents digitally by taking a photograph of the document via a user device. As such, in some embodiments, a user may be able to deposit one or more checks using a user device. Currently, the user device provides a the photograph to an entity system to perform optical character recognition on the checks and provides a receipt to the user all being performed within an application on the user device. Subsequently, the checks are processed after they have been deposited. As such, if one or more of the checks the user deposited is held for any reason, the user may not know about the hold until well after the user has deposited the checks. This invention alleviates the delay and provides the user with a real-time determination of the checks upon being deposited. As such, the user may know in real-time, whether a check is being held for one or more reasons, the reason for the hold, and the like. Typically, if one check is being held within a batch deposit, all of the checks within the batch deposit are delayed in processing. However, the invention identifies the specific check being held, isolates that check, and allows the other checks in the batch to process. Furthermore, the system integrates within the display of the user device to present to the user a display with the held check, information about the rationale for holding the check and allows a user to select to reverse the recommendation and cancel the deposition of the potentially held check.

Embodiments of the invention are directed to systems, methods, and computer program products for user device based real-time resource deposition processing. In this way, a hold recommendation screen may be presented on a display of the user device upon identification of a potential hold on one or more physical resource distribution document depositions. The screen may transmit information regarding the hold to the user based on real-time decisioning of processing the resource distribution document. The user able to reverse the recommendation and cancel a specific resource distribution document deposition within a group of resource distribution documents based on the processing hold indication.

The invention provides a real-time paper resource distribution recommendation system. The invention provides a hold recommendation screen and process to a user as the user is depositing checks via a user device. The hold recommendation screen is based on real-time decisions that were made on the backend about check approval. Based on the user's actions at the user device, the system provides the ability to reverse the recommendations if the user asks in real-time. The system notifies the user of a hold and allows the user to cancel a specific item or a group of items and have that item/group returned based on information provided on the screen of the user device.

In this way, the invention allows users to cancel, process, or modify a mobile check deposits if the user receives a hold notification. Furthermore, the system allows the user to view a remaining monthly deposit limit.

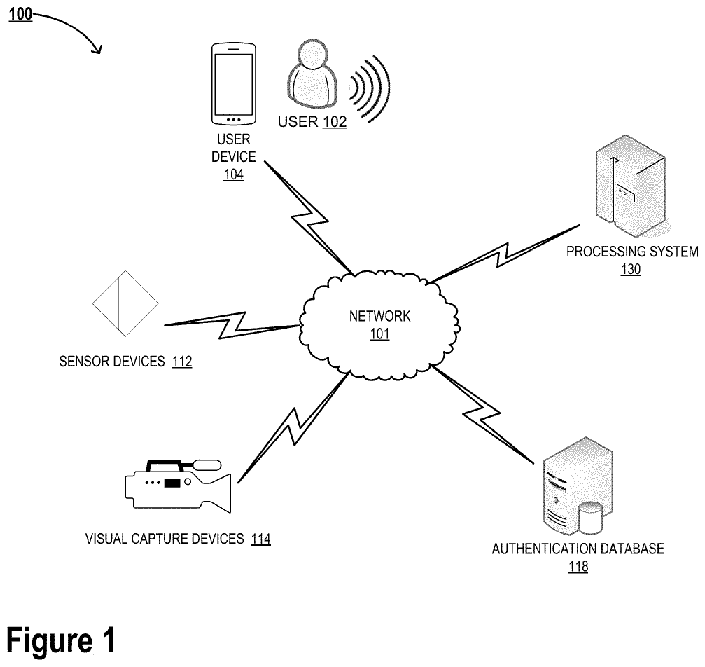

FIG. 1 illustrates a real-time digital recommendation restorer system environment 100, in accordance with embodiments of the invention. As illustrated, the system environment 100 may comprise a user devices 104 associated with a user 102, a processing system 130, one or more sensor devices 112, one or more visual capture devices 114, an authentication database 118, and/or other systems/devices not illustrated herein, via a network 101. As such, the user device 104 is configured such that the user 102 may perform one or more user activities or transactions by utilizing the user device 104 directly (for example, by physically operating an application on the user device 104 its interfaces, using input/output devices of the application, using audio commands, using physical gestures, and the like) and/or via communication between the user device 104 and the application (for example, by establishing operative communication channels between the user device 104 and the application to the processing system 103 via a wireless network and interacting with the user device 104). As such, the user 102 may be depositing one or more checks or resource distribution documents into an account associated with the user 102 at the user device 104. The resource distribution documents may be physical documents required for a photo to be taken at the user device 104 and/or scanned by one or more of the sensor devices 112, visual capture devices 114, or the like associated with the user device 104.

Typically, the processing system 130 and the authentication database 118 are in electronic communication with the application on the user device 104, via the network 101, which may be the internet, an intranet or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104). In this regard, the wireless communication channel may further comprise near field communication (NFC), communication via radio waves, communication through the internet, communication via electromagnetic waves and the like.

As discussed previously, the application on the user device 104 is configured to facilitate performance of user activities, and is configured to provide real-time interactive sessions for the user 102. In some embodiments, the application is on the user device 104 and is configured for uniquely facilitating user activities in accordance with some embodiments, while ensuring the security and privacy of the user.

In some embodiments, the application on the user device 104 receives signals, images and other data captured by the sensor devices 112 and/or the visual capture devices 114, during its execution of user activities. In this way, the sensor devices 112 and/or the visual capture devices 114 may be associated with, integrated within, or otherwise in communication with the application on the user device 104. In this regard, in some embodiments, the user device 104 communicates with, transmits instructions, and/or receives signals from the sensor devices 112 and the visual capture devices 114 directly, via the network 101, typically, in real-time. In some embodiments, the user device 104 communicates with the sensor devices 112 and the visual capture devices 114 through the processing system 130, typically, in real-time. Analyzing the signals received from the sensor devices 112 and the visual capture devices 114 typically enables the application, the user device 104, the processing system 130, or the devices 112 and 114 themselves, to determine user location, determine trigger events (e.g., user accessing and authorizing into the application on the user device 104, retrieve/identify user authentication credentials from the user and/or the user device, establishing communication with the user device, determination of whether the user device comprises an integrated resource transfer application, and the like), capture one or more parameters associated with the environment or physical location of the user device 104, and the like.

In some embodiments, the sensor devices 112 are position sensors configured to sense or determine the position and/or location of the user 102, other individuals, objects/devices. As such, the sensor devices 112 may determine an absolute positon (for example, location/positioning coordinates) or a relative position (for example, with respect to the position of the user device 104, with respect to position of the user or another individual, with respect to the sensor 112 itself or a predetermined object and the like) of the user, individual or object. Here, in some embodiments, the sensor devices 112 are proximity sensors that are configured to determine the presence of the user or object within a predetermined proximity area. These sensor devices 112 may be contact type sensors that determine the presence of the user or object based on contact, or non-contact type sensors that detect distant users or objects.

The visual capture devices 114 typically comprise cameras and other audio, video and image capture devices. These visual capture devices 114 are configured to capture images and/or video streams, typically in real-time, of a predetermined proximity area. The images and/or video streams may be analyzed by the user device 104, the processing system 130 and/or the capture devices 114, to determine the presence and position of the user, other individuals or objects and their movement in the proximity area. Although described separately, it is understood that the visual capture devices 114 may be associated with the sensor devices 112. As such, sensors or sensor devices, as alluded to herein, may refer to the various sensor devices described herein and the visual/image capture devices described herein.

As alluded to previously, the processing system 130 is in operative communication with the user device 104. In some embodiments, processing system 130 is configured to transmit control instructions that are configured to cause the application, the user device 104, the sensor device 112, and/or the visual capture devices 114 to perform at least a portion of the steps associated with one or more activities. The processing system 130 may be associated with the same entity as the application or may be associated with another entity. The processing system 130 may further communicate with the authentication database 118, either directly or indirectly. The authentication database 118 may comprise authentication credentials associated with the user 102. The processing system 130 and/or the user device 104 may retrieve the authentication credentials from the authentication database to authenticate the user prior to executing one or more user activities or transactions.

The user device 104 may comprise a mobile communication device, such as a cellular telecommunications device (i.e., a smart phone or mobile phone), a computing device such as a laptop computer, a personal digital assistant (PDA), a mobile internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. As discussed previously, in some embodiments, the user device 104 of the present invention are configured to establish operative communication channels with the processing system 130 such that, the user 102 may perform one or more user activities, either entirely or in part, by interacting with the user device 104.

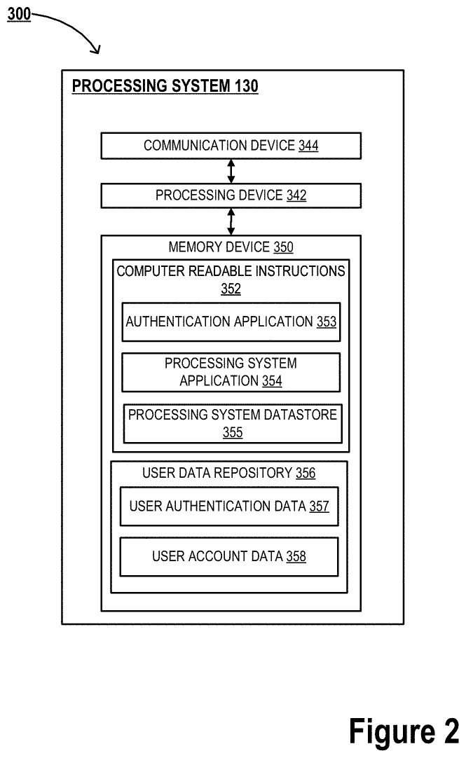

FIG. 2 illustrates a block diagram of the processing system associated with the real-time recommendation restorer system environment 300, in accordance with embodiments of the present invention. As illustrated in FIG. 2, the processing system 130 may include a communication device 344, a processing device 342, and a memory device 350 having an authentication application/module 353, a processing system application 354 and a processing system datastore 355 stored therein. As shown, the processing device 342 is operatively connected to and is configured to control and cause the communication device 344, and the memory device 350 to perform one or more functions. Furthermore, the processing device 342 is typically configured to control and cause the sensor devices 112, and visual capture devices 114, or user device 104 to perform one or more functions. In some embodiments, the authentication application 353 and/or the processing system application 354 comprises computer readable instructions that when executed by the processing device 342 cause the processing device 342 to perform one or more functions and/or transmit control instructions to the user device 104, the authentication database 118, the sensor devices 112, and visual capture devices 114, and/or the communication device 344. It will be understood that the authentication application 353 and/or the processing system application 354 may be executable to initiate, perform, complete, and/or facilitate one or more portions of any embodiments described and/or contemplated herein, and specifically embodiments directed to user activities. The authentication application 353 may comprise executable instructions associated with one or more authentication steps of user activities, and may be embodied within the processing system application 354 in some instances. In some embodiments, the authentication application 353 comprises computer readable instructions that when executed by the processing device 342 cause the processing device to perform one or more functions and/or transmit control instructions to other components or devices to perform one or more authentication steps described herein. These authentication steps typically include requesting authentication credentials from the user via the user output devices (for example, based on determining the desired authorization level for the user activity), activating pertinent sensors and devices for receipt of the credentials (sensor devices 112/image capture devices 114 for biometric credentials, card reader devices for reading magnetic strips of the user's card(s), contact less interface device for receiving authentication tokens from a user device via NFC channels, and the like), receiving authentication credentials, validating the credentials (for example based on retrieving user credentials from the datastore, memory 350, processing system 130 and/or database), and the like. That said, as shown, the processing device 342, in turn, is operatively connected to and is also configured to control and cause the communication device 344, the memory device 350, and other components described herein to perform one or more functions, at least in part.

The processing system 130 may be owned by, operated by and/or affiliated with financial institutions or other entities. Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that may provide payment accounts for transactions. In accordance with embodiments of the invention, the term “financial institution” refers to any organization in the business of moving, investing, or lending money, dealing in financial instruments, or providing financial services. This includes commercial banks, thrifts, federal and state savings banks, savings and loan associations, credit unions, investment companies, merchants, insurance companies and the like.

The communication device 344 may generally include a modem, server, transceiver, and/or other devices for communicating with other devices on the network 101. The network communication device 344 may be a communication interface having one or more communication devices configured to communicate with one or more other devices on the network 101, such as the processing system 130, the sensor devices 112, and visual capture devices 114, other processing systems, data systems, and the like.

Additionally, referring to processing system 130 illustrated in FIG. 2, the processing device 342 may generally refer to a device or combination of devices having circuitry used for implementing the communication and/or logic functions of the processing system 130. For example, the processing device 342 may include a control unit, a digital signal processor device, a microprocessor device, and various analog-to-digital converters, digital-to-analog converters, and other support circuits and/or combinations of the foregoing. Control and signal processing functions of the system 130 may be allocated between these processing devices according to their respective capabilities. The processing device 342 may further include functionality to operate one or more software programs based on computer-executable program code 352 thereof, which may be stored in a memory device 350, such as the processing system application 354 and the authentication application 353. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 342 may be configured to use the network communication interface of the communication device 344 to transmit and/or receive data and/or commands to and/or from the other devices/systems connected to the network 101.

The memory device 350 within the processing system 130 may generally refer to a device or combination of devices that store one or more forms of computer-readable media for storing data and/or computer-executable program code/instructions. For example, the memory device 350 may include any computer memory that provides an actual or virtual space to temporarily or permanently store data and/or commands provided to the processing device 342 when it carries out its functions described herein. The processing system 130 may be used by a third party to interact with the user device 104, based on providing requisite authorization. The processing system 130 may further comprise a user data repository 356 comprising user authentication data 357 and user account data 358. The processing system 130 may utilize the authentication data 357 to validate user authentication credentials. Furthermore, the account data 358 may reflect the current account data of the user.

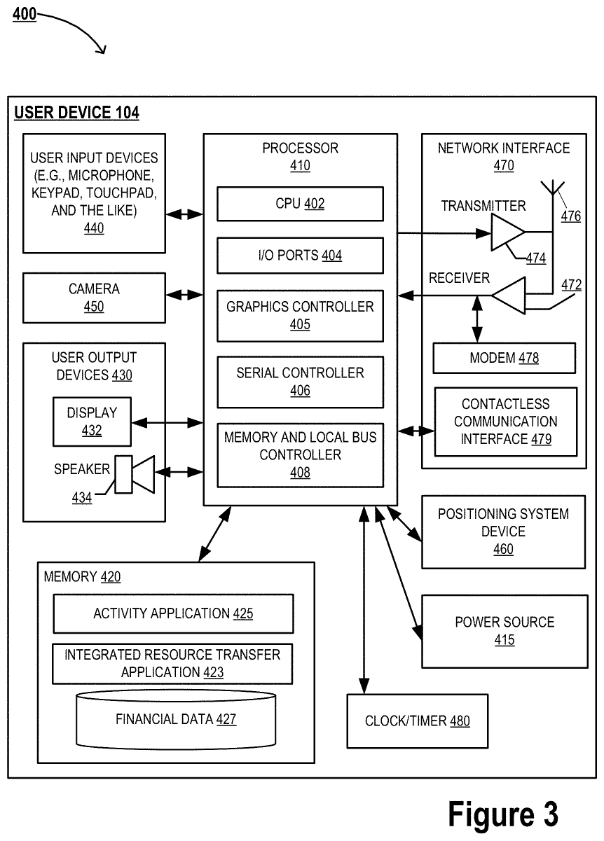

FIG. 3 illustrates a block diagram of the user device 400, in accordance with embodiments of the present invention. The user device 104 may include a user mobile device or the like. A “mobile device” 104 may be any mobile communication device, such as a cellular telecommunications device (i.e., a cell phone or mobile phone), personal digital assistant (PDA), a mobile Internet accessing device, or another mobile device including, but not limited to portable digital assistants (PDAs), pagers, mobile televisions, gaming devices, laptop computers, cameras, video recorders, audio/video player, radio, GPS devices, any combination of the aforementioned devices.

The mobile device 104 may generally include a processing device or processor 410 communicably coupled to devices such as, a memory device 420, user output devices 430 (for example, a user display device 432, or a speaker 434), user input devices 440 (such as a microphone, keypad, touchpad, touch screen, and the like), a communication device or network interface device 470, a power source 415, a clock or other timer 480, a visual capture device such as a camera 450, a positioning system device 460, such as a geo-positioning system device like a GPS device, an accelerometer, and the like, one or more chips, and the like. The processor 410 may further include a central processing unit 402, input/output (I/O) port controllers 404, a graphics controller 405, a serial bus controller 406 and a memory and local bus controller 408.

The camera 450 or image capture device typically comprises cameras and other audio, video and image capture devices. The camera 450 is configured to capture images and/or video streams, typically in real-time, of a predetermined proximity area in the vicinity of the user device 104 location. The images and/or video streams may be analyzed by the application to determine the presence and position of the user, other individuals or objects and their movement in the proximity area, to identify the user for authentication or facial recognition purposes, and the like. In some embodiments, the system is configured to present a customized interface for the user based on identifying the user using facial recognition.

The processor 410 may generally refer to a device or combination of devices having circuitry used for implementing the communication and/or logic functions of the user device 104. For example, the processor 410 may include a control unit, a digital signal processor device, a microprocessor device, and various analog-to-digital converters, digital-to-analog converters, and other support circuits and/or combinations of the foregoing. Control and signal processing functions of the user device 104 may be allocated between the processor according to their respective capabilities.

The processor 410 may include functionality to operate one or more software programs or applications, which may be stored in the memory device 420. For example, the processor 410 may be capable of operating applications such as the activity application 425, a integrated resource transfer application 423, or a web browser application. The activity application 425 may then allow the mobile device 104 to transmit and receive data and instructions from the application, user device 104 (for example, via wireless communication or NFC channels), data and instructions from the processing system 130, web content, such as, for example, location-based content and/or other web page content.

The integrated resource transfer application 423 and the financial data module 427, together may include the necessary circuitry to provide token storage and transmission functionality, transmitter device signal encoding and decoding functionality to the mobile device 104, for secure transmission of financial and authentication credential tokens via the contactless communication interface 479. That said, in some embodiments the integrated resource transfer application 423 is pre-installed on the user device 104.

The processor 410 may be configured to use the network interface device 470 to communicate with one or more other devices on a network 101 such as, but not limited to the processing system 130. In this regard, the network interface device 470 may include an antenna 476 operatively coupled to a transmitter 474 and a receiver 472 (together a “transceiver”), modem 478 and a contactless communication interface 479. The processor 410 may be configured to provide signals to and receive signals from the transmitter 474 and receiver 472, respectively. In this regard, the mobile device 104 may be configured to operate with one or more air interface standards, communication protocols, modulation types, and access types. By way of illustration, the mobile device 104 may be configured to operate in accordance with any of a number of first, second, third, and/or fourth-generation communication protocols and/or the like.

The network interface device 470 or communication device 470 may also include a user activity interface presented in user output devices 430 in order to allow a user 102 to execute some or all of processes described herein. The application interface may have access to the hardware, for example, the transceiver, and software previously described with respect to the network interface device 470. Furthermore, the application interface may have the ability to connect to and communicate with an external data storage on a separate system within the network 101. As described above, the mobile device 104 includes a display device 432 having a user interface that includes user output devices 430 and/or user input devices 440. The user output devices 430 may include a display 432 (e.g., a liquid crystal display (LCD) or the like) and a speaker 434 or other audio device, which are operatively coupled to the processor 410. The user input devices 440, which may allow the mobile device 104 to receive data from the user 102, may include any of a number of devices allowing the mobile device 104 to receive data from a user 102, such as a keypad, keyboard, touch-screen, touchpad, microphone, mouse, joystick, other pointer device, button, soft key, and/or other input device(s).

The mobile device 104 may further include a power source 415. Generally, the power source 415 is a device that supplies electrical energy to an electrical load. In some embodiment, power source 415 may convert a form of energy such as solar energy, chemical energy, mechanical energy, and the like, to electrical energy. Generally, the power source 415 in a mobile device 104 may be a battery, such as a lithium battery, a nickel-metal hydride battery, or the like, that is used for powering various circuits, for example, the transceiver circuit, and other devices that are used to operate the mobile device 104. Alternatively, the power source 415 may be a power adapter that can connect a power supply from a power outlet to the mobile device 104. In such embodiments, a power adapter may be classified as a power source “in” the mobile device 104.

The mobile device 104 may also include a memory buffer, cache memory or temporary memory device operatively coupled to the processor 410. Typically, one or more applications 425 and 423, are loaded into the temporarily memory during use. As used herein, memory may include any computer readable medium configured to store data, code, or other information. The memory device 420 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

As illustrated by FIG. 3, the memory device 420 typically comprises an activity application 425, an integrated resource transfer application 423, and a financial datastore 427 stored therein. In some embodiments, the applications and/or the modules may be executable to initiate, perform, complete, and/or facilitate one or more portions of any embodiment described and/or contemplated herein, either independently or in response to receiving control instructions from the processing system 130. In some embodiments, the application comprises computer readable instructions stored in the memory 420, which when executed by the processor 410, are configured to cause the processor 410 to perform one or more steps of the embodiments presented herein, and/or cause the processing device to transmit control instructions to other components of the user device and other devices/systems in the network 101 to cause them to perform the steps. Generally, the application is executable to receive activity instructions from the user and perform user activities and the various steps described herein. In some embodiments, the application comprises a personal digital assistant for interfacing with the user. The application may be coupled to a computer terminal application datastore 236 for storing application data as the user activity is being performed. The application datastore may store the application data temporarily for the predetermined duration of the execution of the activity (such as a memory buffer, or cache memory), or permanently.

It is understood that the servers, systems, and devices described herein illustrate one embodiment of the invention. It is further understood that one or more of the servers, systems, and devices can be combined in other embodiments and still function in the same or similar way as the embodiments described herein.

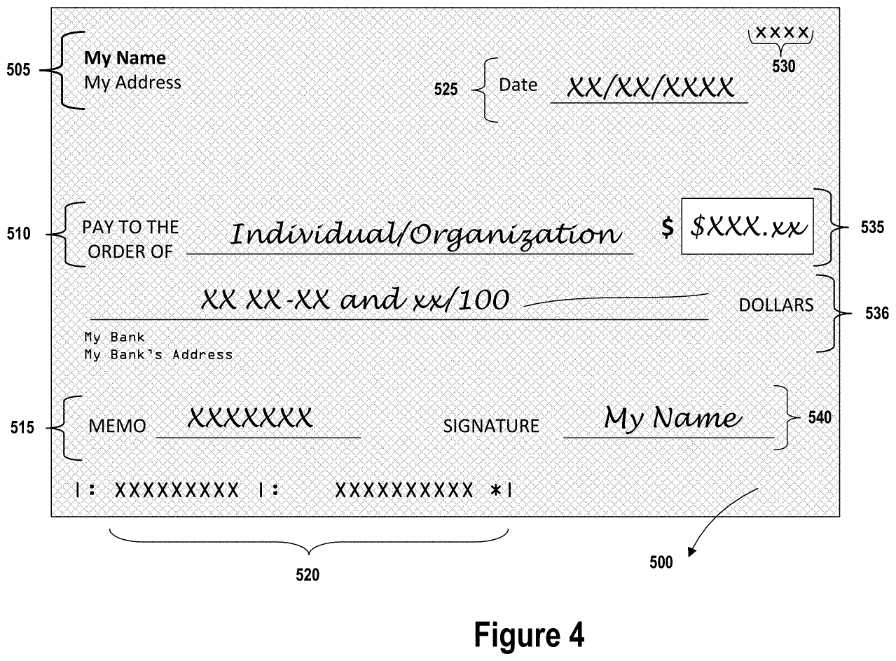

FIG. 4 illustrates an exemplary image of a resource distribution document 500, in accordance with one embodiment of the present invention. In some embodiments, the resource distribution document is a check, as illustrated in FIG. 4. The check comprise the front portion of a check, the back portion of a check, or any other portions of a check. In cases where there are several checks piled into a stack, multiple checks may include, for example, at least a portion of each of the four sides of the check stack. In this way, any text, numbers, or other data provided on any side of the check stack may also be used in implementing the process. In some embodiments the system may receive the physical resource distribution documents via a photograph image taken from via the user device.

Although a check is illustrated in FIG. 4, it will be understood that any type of resource distribution document may be received via imaging. In some embodiments, a customer or other entity takes a picture of a check and communicates the resulting check image to a point via wireless technologies, NFC, radio frequency identification (RFID), and other technologies.

FIG. 4 provides an illustration of an exemplary image of a resource document 500. The resource document illustrated in FIG. 4 is a check. However, one will appreciate that any financial record, financial document, payment instrument, or the like may be provided as a resource document.

The check 500 comprises check information, wherein the check information comprises contact information 505, the payee 510, the memo description 515, the account number and routing number 520 associated with the appropriate user or customer account, the date 525, the check number 530, the amount of the check 535, the legal tender amount 536, the signature 540, or the like. In some embodiments, the check information may comprise text. In other embodiments, the check information may comprise an image.

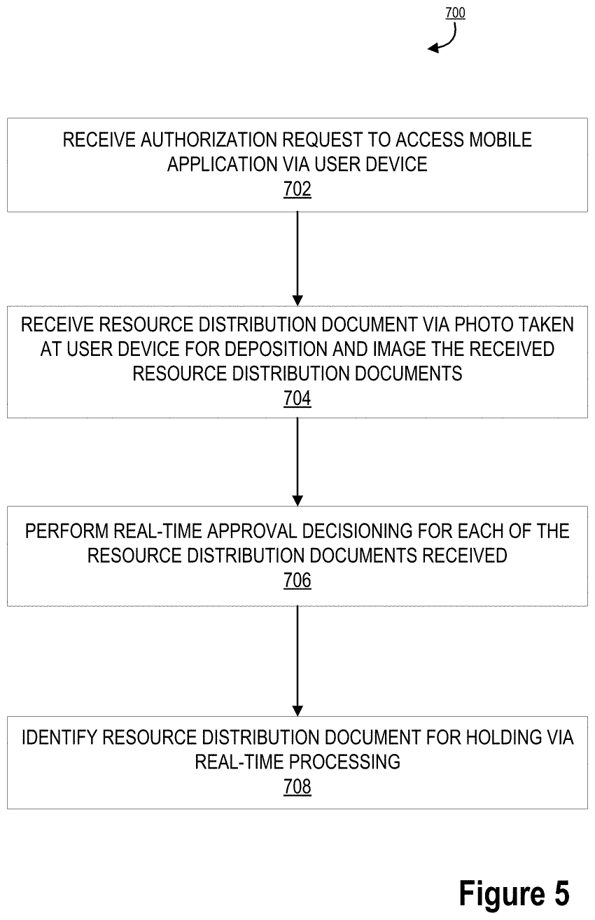

FIG. 5 illustrates a process of triggering real-time resource distribution document restoration 700, in accordance with embodiments of the present invention. As illustrated in block 702, the process 700 is initiated by receiving an authorization request to access a mobile application via a user device. The user may access the application via biometric scan, username/password presentation, or the like. The user may select the application and authorize into the application associated with the system. Once the user is authorized into the application on the user device the user may select via the display to deposit a single check, multiple checks, or a bulk of checks via taking a photograph of the front and back of the check with the camera associated with the user device.

Next, as illustrated in block 704, the process continues by receiving the resource distribution document via a photograph taken at the user device for deposition. The system may then recognize the received photograph and image the received resource distribution documents. In this way, the processing system may recognize the received checks and initiate real-time processing of the resource distribution documents. This may include an initial optical character recognition (OCR) scan of the physical resource distribution document. As such, the OCR performed may image the received resource distribution documents.

Next, as illustrated in block 706, the process 700 continues by performing real-time approval decisioning for each of the resource distribution documents received. In this way, the system may perform a real-time approval decisioning to identify if the check is authentic and/or if the check may need to be held for further analysis. The hold may be performed for misappropriated checks, exception processing checks, or the like. The performance of real-time approval decision processing may identify resource distribution documents for holding based on the processing, as illustrated in block 708.

The determination of the hold is based on the real-time processing. Typically this processing is not done in real-time, but instead, the check is typically scanned and temporarily deposited into the appropriate account selected by the user. However, this invention provides a real-time initial processing of the check to scan the image and identify a probability of a hold occurring. This may be due to an exception on the check or the image, an identification of misappropriation, or the like. The initial processing may at least partially eliminate funds from the check being processed and deposited but then subsequently having to be removed due to an exception or hold. As such, the invention provides a unique real-time processing decision for holding of the checks at the point of deposit with the user device.

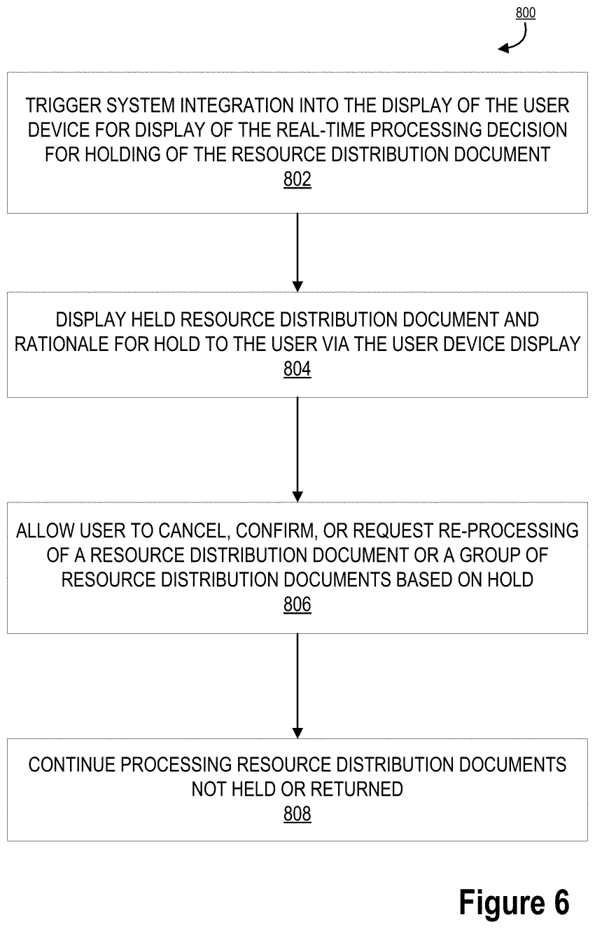

FIG. 6 illustrates a process of restoring a resource distribution document 800, in accordance with embodiments of the present invention. Once the system has identified one or more resource distribution documents for holding, the system may trigger the real-time resource distribution restorer system. As illustrated in block 802, the process 800 is initiated by triggering a system integration into the display of the user device for displaying, to the user, the real-time processing decision for the holding of the one or more resource distribution documents. As illustrated in block 804, the process 800 continues by displaying the held resource distribution document and the rationale for the hold to the user via the user device display. In this way, the system may provide the user with an indication as to why the check was held and a display of which check or checks were held on the ATM display. The display allows the user to visualize the check that is potentially being held. The determination of the hold is based on an initially real-time processing. Typically this processing is not done in real-time, but instead downstream as described above. As such, it is unique that the user has an opportunity to review the held check and confirm the hold, request cancelation and return, or request re-processing of the check during the transaction session.

As illustrated in block 806, the process 800 continues by allowing the user to cancel the deposition of the check, confirm the hold of the check and allow for downstream processing, or request the system re-process the resource distribution document or group of resource distribution documents based on the hold identified by the real-time decisioning.

In some embodiments, the user is allowed to cancel the deposition of the check via the user device display. In this way, the system will not proceed with processing of any other checks in the batch. This will allow the user to deposit the check at another location and does not continue the processing of the check for depositing. In some embodiments, the user may confirm the hold of the check via the user device display. In this way, the user may notice the same issue or agree with the system that a hold should be put on this particular check for exception processing or the like. The user may select and allow for the system to continue processing the check. However, the user knows in real-time that there is a hold on that check and can reconciliate that hold and potential delay while still allowing the held check to process through downstream exception processing. In some embodiments, the user may request the system re-process the check. As such, the user may identify an inconsistency in the scan of the check or the reason for the hold. As such, the user may request the system re-scan the check and perform a follow up real-time decision processing to confirm the hold.

As illustrated in block 808, the process 800 continues by continuing the processing of the resource distribution documents that where batched together and not held or returned to the user. As such, these check may be processed in the traditional check processing manner and posted to the appropriate account based on the traditional processing after the real-time decisioning.

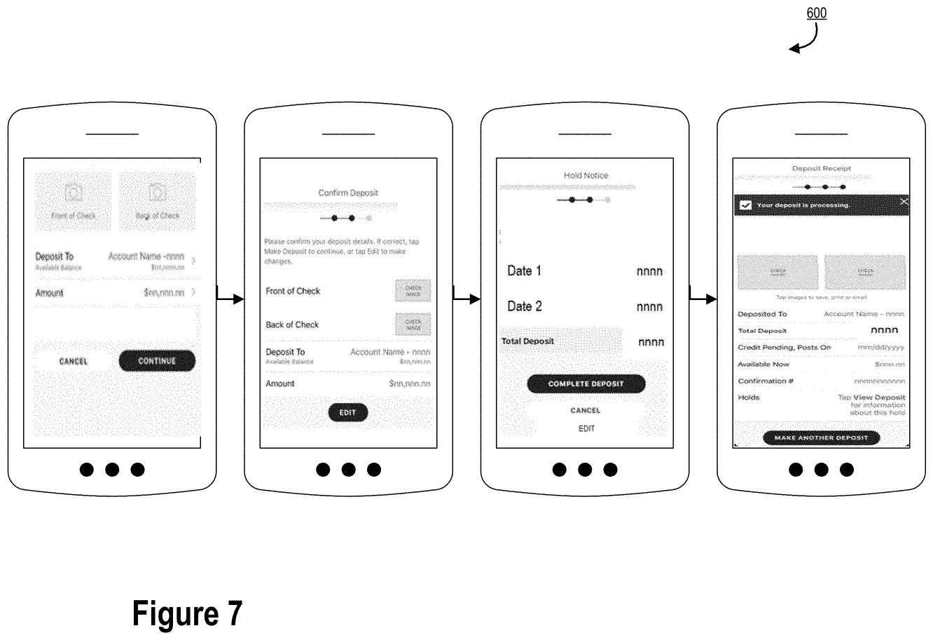

FIG. 7 illustrates a user device interface during the process of restoring a resource distribution document 600, in accordance with embodiments of the present invention. As illustrated, the process 600 is initiated by the user opening an application on a user device. The user may be required to authorize or authenticate into the application. The application may be a financial institution application or another application for the user to review user resources. In this way, the user may access and select to deposit the resource distribution document. The application may allow the user to take a photograph of the front and the back of the resource distribution document. Furthermore, the application may allow the user to select an account do distribute the resources form the resource distribution document into and the like. Next, the process continues by allowing the user to take a photograph of the front and back of the check and to confirm the disposition of the resources.

Next, the system may identify, in real-time, a hold of one or more of the resource distribution documents that the user is attempting to deposit. Upon the identification, the system may provide a hold notification display. The display may show the held checks and the predicted date that a hold will be processed for deposition. The user may be allowed to complete the deposit, cancel the deposit, and/or potentially edit the deposit.

As illustrated next, the process continues by providing a receipt of the deposit and a notification of resources available immediately and those held or canceled.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for real-time physical resource distribution document processing and restoring, the system comprising:
a memory device with computer-readable program code stored thereon;
a communication device;
a printing device for printing the resource distribution documents;
a processing device operatively coupled to the memory device and the communication device, wherein the processing device is configured to execute the computer-readable program code to:
integrate within a user device via an application for management and deposition of physical resource documents by a user;
authorize the user access to the application based on authentication requirement satisfaction by the user;
allow imaging of physical resource distribution documents via the user device for user deposition;
perform character recognition on the imaged physical resource distribution documents;
perform real-time approval decision processing for each of the imaged physical resource distribution documents;
identify one or more imaged resource distribution documents for holding based on the real-time approval decision processing;
present, via a display on the user device, the identification of one or more imaged resource distribution documents for holding;
allow user cancelation, confirmation, or request for re-processing of held one or more imaged resource distribution documents; and
continue downstream processing of imaged resource distribution documents not held.

2. The system of claim 1, wherein performing real-time approval decision processing further comprises performing an initial approval decision on the imaged physical resource distribution document to determine if a hold on processing the imaged physical resource distribution document downstream will occur, wherein a hold is based on an identification of an exception or misappropriation.

3. The system of claim 1, wherein presenting, via the display on the user device, the identification of one or more resource distribution documents for holding further comprises displaying an image of the one or more resource distribution documents for holding and a rationale for the holding.

4. The system of claim 1, wherein allowing user cancelation, confirmation, or request for re-processing of held one or more imaged resource distribution documents further comprises triggering a display on the user device allowing for user selection.

5. The system of claim 1, wherein allowing for cancelation of the held one or more imaged physical resource distribution documents further comprises returning the physical resource distribution document associated with the held one or more imaged physical resource distribution documents to a pre-processed state, wherein allowing the held one or more imaged physical resource distribution documents to be deposited at another location.

6. The system of claim 1, wherein the physical resource distribution document is a check.

7. The system of claim 1, wherein the user device is a mobile device.

8. A computer program product for real-time physical resource distribution document processing and restoring with at least one non-transitory computer-readable medium having computer-readable program code portions embodied therein, the computer-readable program code portions comprising:
an executable portion configured for integrating within a user device via an application for management and deposition of physical resource documents by a user;
an executable portion configured for authorizing the user access to the application based on authentication requirement satisfaction by the user;
an executable portion configured for allowing imaging of physical resource distribution documents via the user device for user deposition;
an executable portion configured for performing character recognition on the imaged physical resource distribution documents;
an executable portion configured for performing real-time approval decision processing for each of the imaged physical resource distribution documents;
an executable portion configured for identifying one or more imaged resource distribution documents for holding based on the real-time approval decision processing;
an executable portion configured for presenting, via a display on the user device, the identification of one or more imaged resource distribution documents for holding;
an executable portion configured for allowing user cancelation, confirmation, or request for re-processing of held one or more imaged resource distribution documents; and
an executable portion configured for continuing downstream processing of imaged resource distribution documents not held.

9. The computer program product of claim 8, wherein performing real-time approval decision processing further comprises performing an initial approval decision on the imaged physical resource distribution document to determine if a hold on processing the imaged physical resource distribution document downstream will occur, wherein a hold is based on an identification of an exception or misappropriation.

10. The computer program product of claim 8, wherein presenting, via the display on the user device, the identification of one or more resource distribution documents for holding further comprises displaying an image of the one or more resource distribution documents for holding and a rationale for the holding.

11. The computer program product of claim 8, wherein allowing user cancelation, confirmation, or request for re-processing of held one or more imaged resource distribution documents further comprises triggering a display on the user device allowing for user selection.

12. The computer program product of claim 8, wherein allowing for cancelation of the held one or more imaged physical resource distribution documents further comprises returning the physical resource distribution document associated with the held one or more imaged physical resource distribution documents to a pre-processed state, wherein allowing the held one or more imaged physical resource distribution documents to be deposited at another location.

13. The computer program product of claim 8, wherein the physical resource distribution document is a check.

14. The computer program product of claim 8, wherein the user device is a mobile device.

15. A computer-implemented method for real-time physical resource distribution document processing and restoring, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
integrating within a user device via an application for management and deposition of physical resource documents by a user;
authorizing the user access to the application based on authentication requirement satisfaction by the user;
allowing imaging of physical resource distribution documents via the user device for user deposition;
performing character recognition on the imaged physical resource distribution documents;
performing real-time approval decision processing for each of the imaged physical resource distribution documents;
identifying one or more imaged resource distribution documents for holding based on the real-time approval decision processing;
presenting, via a display on the user device, the identification of one or more imaged resource distribution documents for holding;
allowing user cancelation, confirmation, or request for re-processing of held one or more imaged resource distribution documents; and
continuing downstream processing of imaged resource distribution documents not held.

16. The computer-implemented method of claim 15, wherein performing real-time approval decision processing further comprises performing an initial approval decision on the imaged physical resource distribution document to determine if a hold on processing the imaged physical resource distribution document downstream will occur, wherein a hold is based on an identification of an exception or misappropriation.

17. The computer-implemented method of claim 15, wherein presenting, via the display on the user device, the identification of one or more resource distribution documents for holding further comprises displaying an image of the one or more resource distribution documents for holding and a rationale for the holding.

18. The computer-implemented method of claim 15, wherein allowing user cancelation, confirmation, or request for re-processing of held one or more imaged resource distribution documents further comprises triggering a display on the user device allowing for user selection.

19. The computer-implemented method of claim 15, wherein allowing for cancelation of the held one or more imaged physical resource distribution documents further comprises returning the physical resource distribution document associated with the held one or more imaged physical resource distribution documents to a pre-processed state, wherein allowing the held one or more imaged physical resource distribution documents to be deposited at another location.

20. The computer-implemented method of claim 15, wherein the physical resource distribution document is a check.
